(19) United States
(12) Patent Application Publication
(10) Pub. No.: US 2026/0128268 A1
(43) Pub. Date: May 7, 2026

(54) TIME-OF-FLIGHT MASS SPECTROMETER

(71) Applicant: SHIMADZU CORPORATION, Kyoto-shi (JP)

(72) Inventor: Tomoya KUDO, Kyoto-shi (JP)

(73) Assignee: SHIMADZU CORPORATION, Kyoto-shi (JP)

(21) Appl. No.: 19/364,307

(22) Filed: Oct. 21, 2025

(30) Foreign Application Priority Data
Nov. 5, 2024 (JP) 2024-193800

(51) Int. Cl. H01J 49/04; H01J 49/40

(52) U.S. Cl. CPC H01J 49/0486; H01J 49/40

(57) ABSTRACT

A TOFMS includes an ion ejection unit, a flight tube, a vacuum chamber in which the flight tube is enclosed, a temperature control unit that controls the temperature of the flight tube, a temperature control section that controls a temperature control operation by the temperature control unit based on an indirectly or directly measured temperature of the flight tube and a target temperature; a temperature sensor that measures an ambient temperature, which is a temperature outside the vacuum chamber; a prediction unit that predicts, based on the ambient temperature and the target temperature, a possibility that the temperature of the flight tube will not reach the target temperature or will not fall within a predetermined allowable temperature range including the target temperature even with the temperature control using the temperature control unit; and a notification unit that performs a notification to a user according to a prediction result.

### TECHNICAL FIELD

The present invention relates to a time-of-flight mass spectrometer (TOFMS).

### BACKGROUND ART

In a TOFMS, generally, an ion ejection unit imparts constant kinetic energy to ions to be analyzed, introduces them into a flight space formed within a flight tube, and causes them to fly through the flight space. Then, the time required for the ions to fly a certain distance is measured, and the mass-to-charge ratio (m/z) of the ions is calculated based on the flight time. Therefore, to achieve high mass accuracy in a TOFMS, it is important to keep the flight distance constant.

If the flight tube expands or contracts due to temperature changes, the flight distance changes, leading to a decrease in mass accuracy. Therefore, in the TOFMS described in Patent Literatures 1 and 2, a configuration is adopted in which a temperature control unit including a heater is provided on the outside of a vacuum chamber that encloses the flight tube, and the flight tube is indirectly heated using the temperature control unit so that the directly or indirectly detected flight tube temperature reaches a target temperature (45° C. in the example described in Patent Literature 2).

However, since the heating capacity of the heater is limited, if the room temperature is too low, the flight tube may not reach the target temperature. Conversely, if the room temperature is too high, the flight tube temperature may exceed the target temperature. Therefore, in conventional TOFMS, a measure is taken to detect whether the flight tube temperature is within a predetermined allowable temperature range that includes the target temperature, and if the flight tube temperature does not fall within the allowable temperature range even after a predetermined time has elapsed, a temperature control error (timeout error) is displayed to call the user's attention.

### CITATION LIST

### Patent Literature

[Patent Literature 1] International Publication No. WO 2019/224948

[Patent Literature 2] International Publication No. WO 2019/220497

### SUMMARY OF INVENTION

### Technical Problem

Normally, the heat capacity of the vacuum chamber and the flight tube is very large, and the thermal time constant is large. Therefore, it takes a considerable amount of time (for example, several tens of hours) from the start of temperature control of the flight tube until the flight tube temperature reaches the vicinity of the target temperature and stabilizes. Therefore, the predetermined time for determining a timeout error as described above is set to be quite long, and it may be the case that it is not known that the ambient temperature is too low or too high until several tens of hours have passed since the startup of the apparatus. In that case, the user will wait for an unnecessarily long time, which reduces the efficiency of the analysis work.

The present invention has been made to solve such problems, and its main object is to provide a TOFMS that can improve the efficiency of analysis work by appropriately controlling the temperature of the flight tube to ensure high mass accuracy and reducing wasted work time related to the temperature control.

### Solution to Problem

One aspect of the present invention is a TOFMS comprising an ion ejection unit, a flight tube that forms a space in which ions ejected from the ion ejection unit fly, a vacuum chamber in which the flight tube is enclosed, a temperature control unit that controls the temperature of the flight tube, and a temperature control section that controls the temperature control operation by the temperature control unit based on an indirectly or directly measured temperature of the flight tube and a target temperature, the TOFMS further comprising:
a temperature sensor that measures an ambient temperature, which is a temperature outside the vacuum chamber;
a prediction unit that predicts, based on the ambient temperature and the target temperature, a possibility that the temperature of the flight tube will not reach the target temperature or will not fall within a predetermined allowable temperature range including the target temperature even with the temperature control using the temperature control unit; and
a notification unit that performs a notification to a user according to a prediction result by the prediction unit.

### Advantageous Effects of Invention

In the TOFMS of the above aspect according to the present invention, for example, in an initial stage of analysis preparation work such as before the start of temperature control of the flight tube, if it is predicted that there is a high possibility that the temperature of the flight tube will not fall within (reach) the allowable temperature range even with the temperature control using the temperature control unit, the notification unit can issue a warning to the user. As described above, according to the present invention, the user can grasp the possibility that the temperature control of the flight tube will not be performed appropriately at the initial stage of the analysis preparation work, without waiting for a long time until the actual situation of the temperature change of the flight tube becomes clear. Then, if there is such a possibility, the user can promptly take appropriate measures such as adjusting the room temperature or changing the target temperature for temperature control itself. This makes it possible to avoid the occurrence of wasted time related to analysis and shorten the time required for analysis work, thereby improving the efficiency of the analysis work, even in situations where the room temperature is too low or too high.

### BRIEF DESCRIPTION OF DRAWINGS

FIG. 1 A schematic configuration diagram of a main part of a Q-TOFMS according to an embodiment of the present invention.

FIG. 2 A diagram showing an example of a control flowchart during the temperature control startup of the flight tube in the Q-TOFMS of the present embodiment.

FIG. 3 A schematic diagram showing the relationship between the room temperature and the duty ratio for heater control when the target temperature for the temperature control of the flight tube is Ta.

FIG. 4 A configuration diagram of a portion related to the temperature control operation of the flight tube in a Q-TOFMS according to a modification.

FIG. 5 A diagram showing an example of a control flowchart during the temperature control of the flight tube in the Q-TOFMS of the above modification.

### DESCRIPTION OF EMBODIMENTS

A quadrupole-time-of-flight mass spectrometer (Q-TOFMS), which is an embodiment of the TOFMS according to the present invention, will be described with reference to the accompanying drawings.

Note that, in the present embodiment, the TOFMS is a reflectron-type TOFMS of an orthogonal acceleration system, but this is merely an example, and as will be described later, the present invention is not limited to the orthogonal acceleration system, nor is it limited to a reflectron-type TOFMS.

### Configuration and Schematic Operation of Q-TOFMS

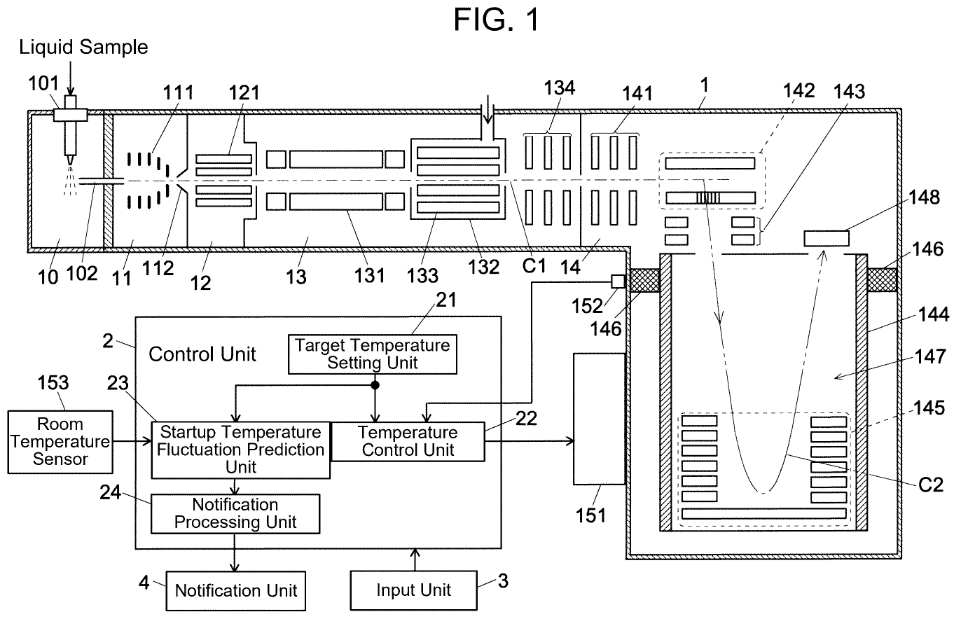

FIG. 1 is an overall configuration diagram of the Q-TOFMS of the present embodiment. The configuration and schematic operation of this Q-TOFMS are as follows.

In this Q-TOFMS, an ionization chamber 10 is connected to the front of a vacuum chamber 1. The interior of the vacuum chamber 1 is roughly partitioned into four chambers: a first intermediate vacuum chamber 11, a second intermediate vacuum chamber 12, a first analysis chamber 13, and a second analysis chamber 14. While the ionization chamber 10 is at approximately atmospheric pressure, each chamber inside the vacuum chamber 1 is evacuated by an appropriate vacuum pump (not shown). As a result, this Q-TOFMS has a multi-stage differential pumping system configuration in which the degree of vacuum increases in stages from the ionization chamber 10 to the first intermediate vacuum chamber 11, the second intermediate vacuum chamber 12, the first analysis chamber 13, and the second analysis chamber 14.

An electrospray ion (ESI) source 101 is arranged in the ionization chamber 10. The ESI source 101 sprays a liquid sample supplied from a liquid chromatograph or the like (not shown) into the ionization chamber 10 while imparting a charge to it. Thereby, compounds in the liquid sample are ionized. However, the ionization method is not limited to this, and an ion source using another ionization method such as an atmospheric pressure chemical ion source, an atmospheric pressure photoionization source, or a probe electrospray ion source may be used.

The ionization chamber 10 and the first intermediate vacuum chamber 11 communicate with each other through a thin desolvation tube 102. The ions derived from the sample components and fine charged droplets generated in the ionization chamber 10 as described above are drawn into the desolvation tube 102 by the pressure difference between the ionization chamber 10 and the first intermediate vacuum chamber 11 and sent to the first intermediate vacuum chamber 11. The desolvation tube 102 is heated to an appropriate temperature, and as the charged droplets pass through the inside of the desolvation tube 102, the vaporization of the solvent in the droplets is promoted, and the generation of ions is encouraged.

A multipole-type ion guide 111 is arranged in the first intermediate vacuum chamber 11, and the ions are focused in the vicinity of the ion optical axis C1 by the ion guide 111 and enter the second intermediate vacuum chamber 12 through an opening at the apex of a skimmer 112. A multipole-type ion guide 121 is also arranged in the second intermediate vacuum chamber 12, and the ions are sent from the second intermediate vacuum chamber 12 to the first analysis chamber 13 by this ion guide 121.

In the first analysis chamber 13, a quadrupole mass filter 131 that separates ions according to m/z, a collision cell 132 provided with an ion guide 133 inside, and an upstream transfer electrode 134 that transports ions exiting from the collision cell 132 are arranged. The ions that have entered the first analysis chamber 13 are introduced into the quadrupole mass filter 131, and only ions having a specific m/z corresponding to the voltage applied to the quadrupole mass filter 131 pass through the quadrupole mass filter 131. A collision gas such as argon is continuously or intermittently supplied into the collision cell 132. The ions that have entered the collision cell 132 with a predetermined energy come into contact with the collision gas and are dissociated by collision-induced dissociation, and various product ions are generated.

The various product ions exiting from the collision cell 132 are sent to the second analysis chamber 14 while being focused by the upstream transfer electrode 134. In the second analysis chamber 14, a downstream transfer electrode 141, an orthogonal acceleration unit 142, a second acceleration electrode unit 143, a flight tube 144, a reflectron 145, a detector 148, and the like are arranged. The ions formed into a thin beam by the downstream transfer electrode 141 are ejected in the orthogonal acceleration unit 142 in a direction substantially orthogonal to the incident direction of the beam (downward direction in FIG. 1). The ejected ions are introduced into a flight space 147 inside the flight tube 144 via the second acceleration electrode unit 143. An electric field that causes the ions to fly back and forth along a path as indicated by C2 in FIG. 1 is formed within the flight space 147 by the flight tube 144 and the reflectron 145. As a result, the ions fly again after being turned back and reach the detector 148.

The ions ejected from the orthogonal acceleration unit 142 as an ion ejection unit fly at a speed corresponding to the m/z of the ions. Therefore, various ions accelerated at the same time are separated according to m/z during flight and reach the detector 148 with a time difference. The detector 148 generates a detection signal in real time according to the amount of ions that have arrived. A data processing unit (not shown) that receives the detection signal obtains the flight time from the detection signal and creates a mass spectrum by converting the flight time into m/z. As a result, a mass spectrum of product ions that reflects the structure of a specific compound in the liquid sample is obtained. Further, in this Q-TOFMS, by causing the ions to pass through the quadrupole mass filter 131 and not performing ion dissociation in the collision cell 132, a mass spectrum corresponding to the compounds contained in the liquid sample can be obtained.

### Configuration Related to Temperature Control of Flight Tube

The flight tube 144 is arranged in the second analysis chamber 14 formed inside the vacuum chamber 1. Specifically, the flight tube 144, which is made of a metal such as stainless steel and has a substantially rectangular tube shape, is attached to the inner wall surface of the vacuum chamber 1 via a plurality of support members 146. A temperature control unit 151 including a heater (not shown) for indirectly controlling the temperature of the flight tube 144 is attached to the outer wall surface of the vacuum chamber 1. Note that the temperature control unit 151 may be one capable of cooling the flight tube 144, or one capable of both heating and cooling. Further, the temperature control unit 151 may have a configuration capable of directly controlling the temperature of the flight tube 144, instead of indirectly. Further, in this embodiment, there is one temperature control unit 151, but a plurality of temperature control units 151 may be provided, as in the apparatus described in Patent Literature 1.

An apparatus temperature sensor 152 is mounted on the outer wall surface of the vacuum chamber 1 at a site where one of the support members 146 is attached. This apparatus temperature sensor 152 indirectly detects the temperature of the flight tube 144, and its detection signal is input to a control unit 2. Further, an indoor temperature sensor 153 for detecting the ambient temperature at an appropriate distance from the vacuum chamber 1 is provided at an appropriate position outside the vacuum chamber 1. The detection signal from this indoor temperature sensor 153 is also input to the control unit 2. Note that, similar to the temperature control unit 151, a plurality of apparatus temperature sensors 152 can also be provided. Further, the apparatus temperature sensor 152 may be one that more directly detects the temperature of the flight tube 144. A plurality of indoor temperature sensors 153 can also be provided.

The control unit 2 is typically composed of a computer including a CPU and the like, and includes, as functional blocks, a target temperature setting unit 21, a temperature control section 22, a startup temperature fluctuation prediction unit 23, and a notification processing unit 24. These functional blocks can be realized by executing software (a program) installed in the computer, but at least a part thereof may be configured by a hardware circuit such as a digital signal processor. Further, an input unit 3 and a notification unit 4, which are a user interface, are connected to the control unit 2. The notification unit 4 may be a display such as a display for performing visual notification, or one that performs acoustic or voice notification such as a buzzer.

### Temperature Control Operation of Flight Tube

If the flight tube 144 expands or contracts due to heat during analysis, the flight distance of the ions changes, causing a mass error. To avoid this, in this Q-TOFMS, the temperature control section 22 included in the control unit 2 controls the temperature control operation by the temperature control unit 151 so that the flight tube temperature is maintained within a predetermined allowable temperature range near the target temperature, based on the target temperature set in the target temperature setting unit 21 and the flight tube temperature estimated based on the detection signal from the apparatus temperature sensor 152. Specifically, the power supplied to the heater included in the temperature control unit 151 is controlled by pulse width modulation (PWM), and the temperature control section 22 controls the heating power by adjusting the duty ratio of the PWM control.

The above-mentioned target temperature is set to a temperature that is higher than a general room temperature (ambient temperature) by an appropriate temperature. In the TOFMS of the present embodiment, the standard target temperature is 42° C., and with a fluctuation of 0.5° C. as an allowable width, 42±0.5° C. (41.5 to 42.5° C.) is the allowable temperature range. However, 42° C. is a default target temperature, and the target temperature can be changed within a predetermined temperature range by an operation from the input unit 3 by the user. Hereinafter, the case where the target temperature is 42° C. will be described in principle, but it is clear from the following description that the target temperature does not have to be 42° C.

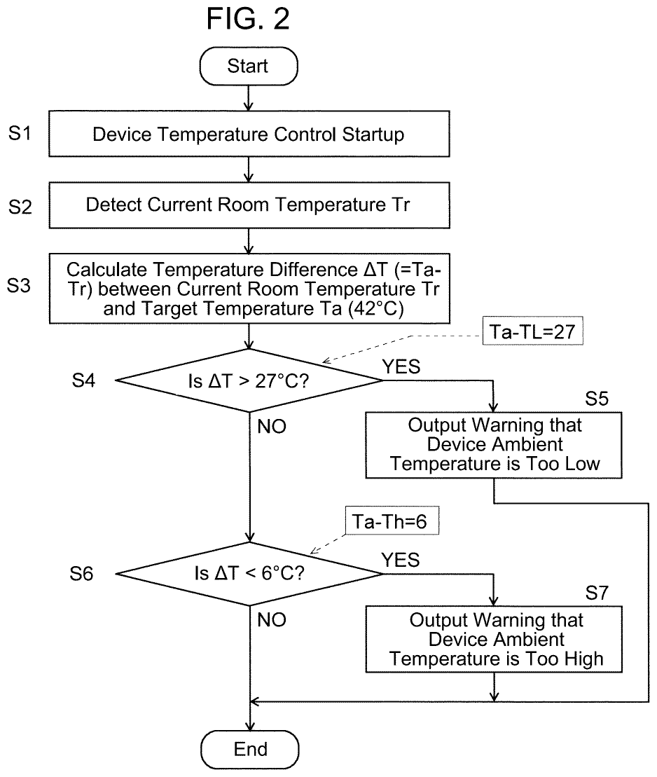

When the present apparatus is in a stopped state or the like, and the temperature control operation by the temperature control unit 151 is not being performed, the temperature of the flight tube 144 is in a state close to room temperature, which is considerably lower than the target temperature. Therefore, to perform analysis, it is first necessary to start the temperature control operation by the temperature control unit 151 and bring the temperature of the flight tube 144 into a state where it falls within the allowable temperature range. FIG. 2 is a diagram showing an example of a control flowchart at the time of temperature control startup of the flight tube in the Q-TOFMS of the present embodiment.

For example, when a temperature control startup is instructed by the user from the input unit 3 (step S1), the startup temperature fluctuation prediction unit 23 reads the detection signal from the indoor temperature sensor 153 and detects the current room temperature Tr (step S2). Next, the startup temperature fluctuation prediction unit 23 acquires information on the target temperature Ta from the target temperature setting unit 21 and calculates the temperature difference ΔT (=Ta−Tr) between the room temperature Tr and the target temperature Ta (step S3). For example, if the target temperature Ta is 42° C. and the current room temperature Tr is 25° C., the temperature difference ΔT=17.

The larger the temperature difference ΔT, the greater the heating power the temperature control section 22 needs to supply to the temperature control unit 151 to bring the temperature of the flight tube 144 closer to the target temperature Ta. However, since there is a limit to the suppliable heating power, if the temperature difference ΔT is too large, the temperature of the flight tube 144 will not reach the allowable temperature range even if the maximum heating power is supplied to the temperature control unit 151. Conversely, when the apparatus is started, the temperature of the flight tube 144 rises to some extent due to heat from various components even without heating by the temperature control unit 151, so if the temperature difference ΔT is too small, the temperature of the flight tube 144 may exceed the allowable temperature range even if the temperature control unit 151 is not operated. Therefore, the startup temperature fluctuation prediction unit 23 determines whether the temperature difference ΔT exceeds 27° C. (step S4), and if it does not exceed 27° C., it then determines whether the temperature difference ΔT is less than 6° C. (step S6). Step S4 is a process for determining whether the room temperature is too low with respect to the target temperature, and step S6 is a process for determining whether the room temperature is too high with respect to the target temperature.

Here, how the determination criteria for the temperatures “27° C.” and “6° C.” in steps S4 and S6 are determined will be described.

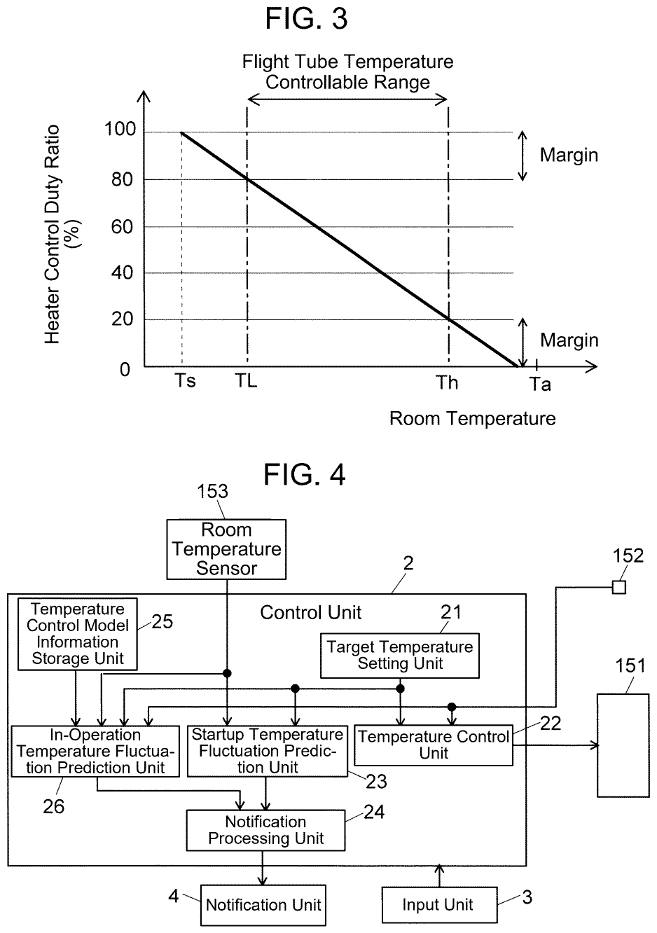

FIG. 3 is a schematic diagram, experimentally obtained, of the relationship between the room temperature and the duty ratio in the PWM control of the heater when the target temperature for the temperature control of the flight tube 144 is Ta. When the duty ratio is 100%, the heating power is full power, and when the duty ratio is 0%, the heating power is zero. As shown in FIG. 3, the duty ratio required to heat the flight tube 144 to the target temperature Ta increases linearly as the room temperature decreases. Ts is the lowest room temperature at which the target temperature Ta can be reached when temperature control is performed with a heating power of a 100% duty ratio, that is, full power, and if the room temperature is lower than this, the temperature of the flight tube 144 cannot reach the target temperature Ta even if temperature control is performed with full power heating.

However, if the control of the heating power supplied to the heater is performed in a state where the duty ratio is close to 100% or 0%, the followability of the control with respect to temperature fluctuations deteriorates, and there is a risk that the stability of the temperature of the flight tube 144 will decrease and the mass stability in analysis will also decrease. Therefore, here, considering a margin of 20% to ensure temperature stability, the appropriate duty ratio range is considered to be 20 to 80%, and the room temperature range in which the flight tube 144 can be appropriately temperature-controlled is set to TL to Th.

As an example, when the target temperature Ta is 42° C., TL is 15° C. and Th is 36° C. Therefore, here, when the target temperature is 42° C., Ta−TL=27° C. is determined as the determination criterion in step S4, and Ta−Th=6° C. is determined as the determination criterion in step S6. Of course, even when the target temperature Ta is different, the determination criterion for the temperature difference ΔT can be determined by a similar method. However, the estimation of the margin of the duty ratio of the PWM control is not limited to the above description, and it can be easily conceived that the method of determining the determination criterion differs depending on the heating control method of the temperature control unit 151. That is, the determination process of step S4 may be any process that predicts that the temperature of the flight tube 144 cannot reach the allowable temperature range even with appropriate temperature control, and the determination process of step S6 may be any process that predicts that the temperature of the flight tube 144 will exceed the allowable temperature range even with appropriate temperature control.

In any case, if YES is determined in steps S4 and S6, it indicates that there is a high possibility that the temperature of the flight tube 144 will not converge to the allowable temperature range appropriate for analysis, even if temperature control by the temperature control unit 151 is performed.

Note that since the determination process of step S4 is a determination by the inequality “Ta−Tr>27”, it is clear that performing the determination by the formula “Ta−27>Tr” obtained by transforming this formula is substantially the same. Similarly, the determination process of step S6 is also substantially the same even if the determination is performed by the formula “Ta−6<Tr”.

If YES is determined in step S4, the notification processing unit 24 outputs a warning notification to the effect that the ambient temperature of the apparatus is too low, through the notification unit 4 (step S5). Further, if YES is determined in step S6, the notification processing unit 24 outputs a warning notification to the effect that the ambient temperature of the apparatus is too high, through the notification unit 4 (step S7). On the other hand, if NO is determined in step S6, it can be estimated that the ambient temperature is appropriate, so the process ends without performing the above-mentioned warning notification at the time of temperature control startup.

As a more specific warning notification in step S5, it is advisable to issue a warning by display or voice, such as “Since the apparatus ambient temperature is too low, the flight tube temperature may not stabilize. Please raise the room temperature to X° C. or higher, or lower the temperature control target temperature to Y° C. or lower.” Further, as a more specific warning notification in step S7, it is advisable to issue a warning by display or voice, such as “Since the apparatus ambient temperature is too high, the flight tube temperature may not stabilize. Please lower the room temperature to X° C. or lower, or raise the temperature control target temperature to Y° C. or higher.”

A user who has received a warning notification as described above may, for example, change the room temperature by adjusting the air conditioning of the room where the Q-TOFMS is placed. Conventionally, it was not known at the time of temperature control startup whether the temperature of the flight tube 144 would eventually fall within the allowable temperature range, and the user could only know that the room temperature was not appropriate after seeing that a timeout error had occurred after several tens of hours had passed since the temperature control startup. In contrast, in the Q-TOFMS of the present embodiment, immediately after the temperature control startup, it is possible to know that there is a high possibility that the temperature of the flight tube 144 will not eventually fall within the allowable temperature range. Therefore, it is possible to quickly resolve the problem caused by the room temperature being too low or too high, without spending wasted waiting time. Then, after several tens of hours have passed since the temperature control startup, analysis can be performed in a state where the temperature of the flight tube 144 has surely fallen within the allowable temperature range.

A user who has received a warning notification as described above may also substantially reduce or expand the temperature difference ΔT by adjusting the target temperature Ta from the input unit 3, instead of adjusting the room temperature. However, if the target temperature for temperature control is changed from the default value (here, 42° C.), the flight distance changes from the case where the temperature of the flight tube 144 is the default value. If the flight distance changes, the relationship between the flight time of the ions and the m/z value changes, so it is usually necessary to redo the work of acquiring mass calibration data by performing actual measurement using a standard sample. Although it is also possible to perform mass calibration using mass calibration data obtained in advance or provided by the apparatus manufacturer without performing such actual measurement, when it is necessary to perform analysis with high mass accuracy, it is preferable to perform the acquisition of mass calibration data by actual measurement as close as possible to the actual measurement for the target sample. Therefore, considering the trouble of acquiring such mass calibration data, it is desirable to adjust the room temperature rather than changing the target temperature Ta.

When the temperature control startup is instructed as described above, the startup temperature fluctuation prediction unit 23 executes the process as shown in FIG. 2, and in parallel, the temperature control section 22 starts the temperature control operation by the temperature control unit 151 based on the detection signal from the apparatus temperature sensor 152 and the target temperature Ta. Therefore, the temperature of the flight tube 144 surely converges to the allowable temperature range, for example, within several tens of hours from the temperature control startup, and becomes a state where analysis is possible.

Note that there may be cases where the temperature of the flight tube 144 does not reach the vicinity of the target temperature due to a problem with the temperature control unit 151, for example, rather than a problem with the setting of the room temperature or the target temperature. Therefore, it is preferable that the Q-TOFMS of the present embodiment also be equipped with a function that is equipped in a conventional apparatus, which detects whether the flight tube temperature is within a predetermined allowable temperature range including the target temperature, displays a temperature control error if the flight tube temperature deviates from the allowable temperature range for a certain period of time or more, and on the other hand, displays that analysis is possible if the flight tube temperature has converged within the allowable temperature range.

Further, in the above description, a warning notification was performed when it was determined that the ambient temperature was too high or too low, and only prompting the user to resolve the problem was done, but an operation to more actively resolve the problem may be executed. Specifically, if YES is determined in steps S4 and S6 above, the target temperature Ta may be automatically changed according to the room temperature at that time. As an example, as described in Patent Literature 2, the target temperature Ta may be changed to a temperature calculated by adding a certain value to the detected room temperature (ambient temperature) (or subtracting it when cooling with the temperature control unit 151). However, as described above, since it is usually desirable to perform reacquisition of mass calibration data when changing the target temperature, it is advisable to automatically change the target temperature and notify that it has been changed.

### Configuration and Operation of Q-TOFMS of a Modification

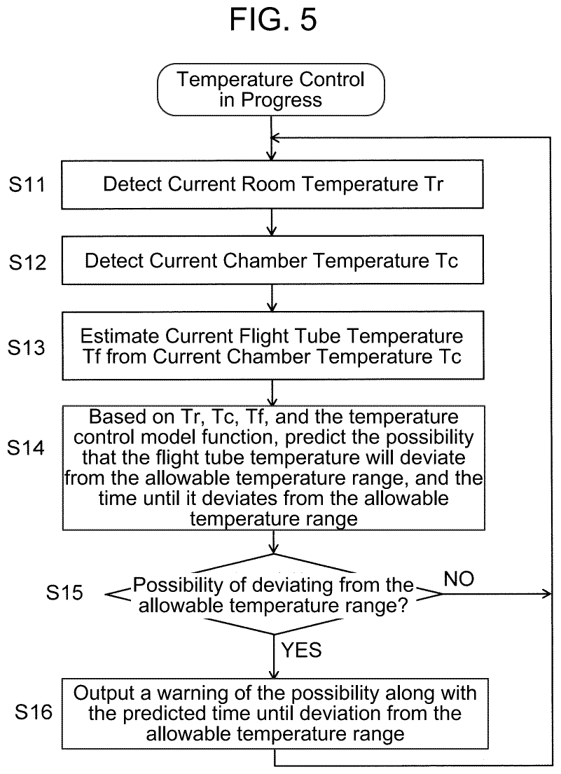

Next, a modification of the Q-TOFMS of the above embodiment will be described with reference to FIGS. 4 and 5. FIG. 4 is a configuration diagram of a portion related to the temperature control operation of the flight tube in the Q-TOFMS of this modification, and FIG. 5 is a diagram showing an example of a control flowchart during the temperature control of the flight tube in the Q-TOFMS of this modification. In FIG. 4, all the configurations inside the vacuum chamber 1 in the Q-TOFMS shown in FIG. 1 are omitted, and the same reference numerals are given to the same or equivalent constituent elements as the configuration shown in FIG. 1.

In the Q-TOFMS of this modification, at the time of temperature control startup, similarly to the above embodiment, the room temperature is detected, and based on the room temperature and the target temperature, it is predicted immediately after the temperature control startup whether the temperature of the flight tube 144 will fall within the allowable temperature range by the temperature control operation. In the Q-TOFMS of this modification, in addition to that, the possibility that the temperature of the flight tube 144 will deviate from the allowable temperature range is continuously predicted even during the execution of temperature control.

As shown in FIG. 4, in the Q-TOFMS of this modification, the control unit 2 further includes, as functional blocks, a temperature control model information storage unit 25 and an in-operation temperature fluctuation prediction unit 26. The temperature control model information storage unit 25 is for storing a temperature control model function created in advance. The temperature control model function is a model function that predicts the temporal fluctuation of the temperature of the flight tube 144, with the room temperature Tr, the temperature of the vacuum chamber 1 Tc, the temperature (current temperature) of the flight tube 144 Tf, and the target temperature Ta as variables. Such a model function can be obtained experimentally in advance by the apparatus manufacturer using a multivariate analysis method. The temperature control model function from the temperature control model information storage unit 25, the detection signal from the indoor temperature sensor 153, the target temperature Ta from the target temperature setting unit 21, and the detection signal from the apparatus temperature sensor 152 are input to the in-operation temperature fluctuation prediction unit 26, and its output is input to the notification processing unit 24.

As described above, under the control of the temperature control section 22, the temperature of the flight tube 144 is controlled by the temperature control unit 151 so that its temperature falls within the allowable temperature range centered on the target temperature Ta. During the execution of such temperature control, the in-operation temperature fluctuation prediction unit 26 reads the detection signal corresponding to the current room temperature Tr from the indoor temperature sensor 153, and the detection signal corresponding to the outer wall temperature Tc of the vacuum chamber 1 from the apparatus temperature sensor 152 (steps S11, S12). Then, based on the outer wall temperature Tc of the vacuum chamber 1, the temperature Tf of the flight tube 144 is estimated using a calculation formula obtained experimentally in advance (step S13).

The in-operation temperature fluctuation prediction unit 26 further applies the room temperature Tr, the temperature of the vacuum chamber 1 Tc, the temperature of the flight tube 144 Tf, and the target temperature Ta to the temperature control model function, and predicts the temporal fluctuation of the temperature of the flight tube 144. Then, based on the prediction result, the possibility that the temperature of the flight tube 144 will deviate from the allowable temperature range is estimated, and if there is a possibility of deviation, the time required until the deviation is estimated (step S14).

If it is predicted in step S14 that there is a possibility that the temperature of the flight tube 144 will deviate from the allowable temperature range, YES is determined in step S15, and the notification processing unit 24 outputs a warning notification from the notification unit 4 to the effect that there is such a possibility, together with the predicted required time until the deviation from the allowable temperature range (step S16). Specifically, a warning such as “There is a possibility of falling outside the temperature control stable range after X hours. Please change the temperature control target temperature or the room temperature” should be displayed. On the other hand, if NO is determined in step S15, there is no problem with the temperature control of the flight tube 144 at least at that point in time, so the process returns to step S11. By repeatedly executing the processing of steps S11 to S16, it is possible to continuously monitor the possibility that the temperature of the flight tube 144 will deviate from the allowable temperature range during the execution of temperature control, that is, during the execution of analysis.

Even if the temperature of the flight tube 144 has once fallen within the allowable temperature range and is stable, if the room temperature drops or rises extremely during analysis, for example, because the air conditioning has stopped, there is a possibility that the temperature of the flight tube 144 will deviate from the allowable temperature range after a certain amount of time has passed. Although a temperature control error also occurs in such cases in conventional apparatuses, the error occurs a considerable amount of time after the room temperature has changed. This is because, as already mentioned, the heat capacity of the vacuum chamber 1 and the flight tube 144 is quite large, so it takes time for the temperature of the vacuum chamber 1 and the flight tube 144 to actually change even if the room temperature changes significantly. Therefore, in a conventional apparatus, if analysis is being performed at the time when a temperature control error occurs, there is a risk that highly accurate data cannot be collected.

In contrast, in the Q-TOFMS of this modification, even during the execution of analysis with the temperature of the flight tube 144 stable, if the room temperature drops or rises extremely and there is a risk that the temperature of the flight tube 144 will deviate from the allowable temperature range after several hours to several tens of hours, the possibility that the temperature of the flight tube 144 will reach a state of deviating from the allowable temperature range is notified along with the predicted time, without a time lag from the change in the room temperature. Therefore, the user can take appropriate measures such as adjusting the air conditioning to return the changed room temperature to the original state. Alternatively, for example, if the analysis can be completed within the predicted time with a margin, the adjustment of the room temperature can be forgone, or if analysis for a plurality of samples is being performed continuously, it is also possible to perform planned and efficient analysis, such as adjusting the number of samples so that the analysis is completed within the predicted time.

### Other Modifications

In the Q-TOFMS according to the above embodiment and modification, the apparatus temperature sensor 152 was attached to the outer wall surface of the vacuum chamber 1 and indirectly detected the temperature of the flight tube 144, but the temperature of the flight tube 144 may be more directly detected inside the vacuum chamber 1. Further, similarly, the temperature control unit 151 may also be one that more directly controls the temperature of the flight tube 144, instead of controlling the temperature of the flight tube 144 via the vacuum chamber 1.

Further, one or both of the apparatus temperature sensor 152 and the temperature control unit 151 may be provided not only one each, but a plurality each. When a plurality of apparatus temperature sensors 152 and a plurality of temperature control units 151 are provided, as described in Patent Literature 1, a configuration can be adopted in which the apparatus temperature sensor 152 and the temperature control unit 151 are provided at different positions along the axial direction of the flight tube 144 (vertical direction in FIG. 1) on the outer wall surface of the vacuum chamber 1, and/or at different positions in a plane orthogonal to the axis of the flight tube 144 on the outer wall surface of the vacuum chamber 1.

Of course, a plurality of indoor temperature sensors 153 may be provided, and an average value of the temperatures detected by the plurality of indoor temperature sensors 153 or a calculated value other than that may be used as the room temperature Tr.

Further, the TOFMS is not limited to the orthogonal acceleration system as shown in FIG. 1, and for example, a configuration in which an ion trap is used as an ion ejection unit, or a configuration in which a matrix-assisted laser desorption/ionization source is used as an ion ejection unit can also be adopted. Further, the TOFMS is not limited to a reflectron type, and the present invention can be applied to any TOFMS in which a flight space is formed inside a flight tube and the flight distance changes depending on the temperature of the flight tube.

Furthermore, the above-described embodiment and modification are merely examples of the present invention, and it is clear that appropriate modifications, changes, additions, and the like made within the scope of the gist of the present invention are also included in the scope of the claims of the present application.

### Various Aspects and their Actions and Effects

It will be understood by those skilled in the art that the exemplary embodiments described above are specific examples of the following aspects.

(Item 1) One aspect of the TOFMS according to the present invention is a TOFMS comprising an ion ejection unit, a flight tube that forms a space in which ions ejected from the ion ejection unit fly, a vacuum chamber in which the flight tube is enclosed, a temperature control unit that controls the temperature of the flight tube, and a temperature control section that controls the temperature control operation by the temperature control unit based on an indirectly or directly measured temperature of the flight tube and a target temperature,
the TOFMS further comprising:
a temperature sensor that measures an ambient temperature, which is a temperature outside the vacuum chamber;
a prediction unit that predicts, based on the ambient temperature and the target temperature, a possibility that the temperature of the flight tube will not reach the target temperature or will not fall within a predetermined allowable temperature range including the target temperature even with the temperature control using the temperature control unit; and
a notification unit that performs a notification to a user according to a prediction result by the prediction unit.

In the TOFMS according to Item 1, for example, in an initial stage of analysis preparation work such as before the start of temperature control of the flight tube, the prediction unit predicts the possibility that the temperature of the flight tube will not fall within the predetermined allowable temperature range even if the temperature control using the temperature control unit is performed, based on the actual ambient temperature from the temperature sensor and the target temperature. This is, for example, a case where the ambient temperature is extremely low or high with respect to the target temperature. If it is predicted that there is a high possibility that the temperature of the flight tube will not fall within the predetermined allowable temperature range, the notification unit issues a warning notification to the user.

In this way, according to the TOFMS described in Item 1, the user can grasp the possibility that the temperature control of the flight tube will not be performed appropriately at the initial stage of the analysis preparation work, without waiting for a long time until the actual situation of the temperature change of the flight tube becomes clear. Then, if there is such a possibility, the user can promptly take appropriate measures according to the situation, such as adjusting the room temperature or changing the target temperature itself. This makes it possible to avoid the occurrence of wasted time related to analysis and shorten the time required for analysis work, thereby improving the efficiency of the analysis work, even in situations where the initial room temperature is too low or too high.

(Item 2) The TOFMS according to Item 1 may further comprise a target temperature setting unit that changes the target temperature according to the prediction result by the prediction unit.

In the TOFMS according to Item 2, the target temperature setting unit lowers the target temperature when the ambient temperature is too low, and raises the target temperature when the ambient temperature is too high. Thereby, it is possible to make the temperature of the flight tube reach the target temperature or fall within the allowable temperature range by the temperature control using the temperature control unit, without adjusting the room temperature. Therefore, even when performing analysis in a place that does not have a function to adjust the room temperature, analysis with high mass accuracy can be performed.

(Item 3) In the TOFMS according to Item 1 or Item 2, the prediction unit may predict the possibility that the temperature of the flight tube will not reach the target temperature or will not fall within the predetermined allowable temperature range before the execution of temperature control by the temperature control unit or immediately after the start of temperature control.

According to the TOFMS described in Item 3, a warning is notified immediately after the temperature control startup of the apparatus when the room temperature is too low or too high. Therefore, the user can recognize that the room temperature is too low or too high with practically no waiting time, and can take appropriate measures such as adjusting the room temperature. Therefore, it is possible to proceed with the analysis efficiently without causing wasted waiting time.

(Item 4) In the TOFMS according to any one of Items 1 to 3, the prediction unit may predict the possibility that the temperature of the flight tube will not reach the target temperature or will not fall within the predetermined allowable temperature range by comparing a difference between the ambient temperature and the target temperature with a predetermined determination reference value.

In the TOFMS according to Item 4, the possibility that the temperature of the flight tube will not reach the target temperature or will not fall within the allowable temperature range can be predicted with high accuracy by a simple calculation process. Therefore, the program (computer software) required to mount such a function may be simple, and the load on the computer can be small.

(Item 5) In the TOFMS according to any one of Items 1 to 4, the prediction unit may predict the possibility that the temperature of the flight tube will not reach the target temperature or will not fall within the predetermined allowable temperature range, assuming that the temperature control unit operates in a range between a capability that is lower than a maximum capability by a predetermined margin and a capability that is higher than a minimum capability by a predetermined margin.

When the temperature control unit is driven by PWM control, generally, the capability of the temperature control unit depends on the duty ratio of the PWM control. Therefore, the range of the capability of the temperature control unit can be rephrased as the range of the duty ratio of the PWM control. Normally, the maximum capability is a duty ratio of 100%, and the minimum capability is a duty ratio of 0%. When the temperature control unit is operated at its maximum capability or in a state very close to it, it is difficult to respond to changes in the ambient temperature because there is no margin in the capability, and the temperature stability deteriorates. This leads to a decrease in mass stability.

In contrast, in the TOFMS according to Item 5, since the temperature control unit does not operate in a state where the duty ratio of the PWM control is in the vicinity of 100% and 0%, the temperature stability is high, and thereby the mass stability during analysis can also be secured.

(Item 6) The TOFMS according to any one of Items 1 to 5 may further comprise an in-operation prediction unit that, during the execution of temperature control by the temperature control unit after the temperature of the flight tube has reached the target temperature or fallen within the predetermined allowable temperature range, predicts a possibility that the temperature of the flight tube will deviate from the target temperature or from the allowable temperature range, based on the ambient temperature, the target temperature, and the temperature of the flight tube, wherein the notification unit may perform a notification to the user according to a prediction result by the in-operation prediction unit.

Even if the temperature of the flight tube stabilizes by temperature control and analysis is started, if the room temperature fluctuates significantly during the analysis, there is a possibility that the temperature of the flight tube will deviate from the allowable temperature range after a considerable amount of time has passed from that point.

In contrast, according to the TOFMS described in Item 6, even if the temperature of the flight tube has once fallen within the allowable temperature range, if the room temperature fluctuates significantly and there is a possibility that the temperature of the flight tube will deviate from the allowable temperature range, a warning notification is promptly performed. This allows the user to promptly take appropriate measures such as checking the room temperature. Further, a situation in which analysis is performed in a state where the temperature of the flight tube has deviated from the allowable temperature range can be avoided, and the execution of inaccurate and wasteful analysis can be prevented.

(Item 7) In the TOFMS according to Item 6, the in-operation prediction unit may predict a required time until the temperature of the flight tube deviates from the target temperature or from the allowable temperature range, and the notification unit may notify the user of the predicted required time.

In the TOFMS according to Item 7, when the room temperature fluctuates significantly during analysis and there is a possibility that the temperature of the flight tube will deviate from the allowable temperature range, the required time until that state is reached, that is, the time for which appropriate analysis can be continued, is notified. Thereby, even if the room temperature cannot be adjusted, for example, it is possible to take appropriate measures such as confirming whether the analysis will be completed within the notified time, or adjusting the number of samples so that the analysis is completed within that time. As a result, the execution of wasteful analysis can be avoided, and efficient analysis work can be performed.

### REFERENCE SIGNS LIST

1 . . . Vacuum chamber
10 . . . Ionization chamber
11 . . . First intermediate vacuum chamber
12 . . . Second intermediate vacuum chamber
13 . . . First analysis chamber
14 . . . Second analysis chamber
101 . . . Electrospray ion (ESI) source
102 . . . Desolvation tube
111, 121, 133 . . . Ion guide
112 . . . Skimmer
131 . . . Quadrupole mass filter
132 . . . Collision cell
134 . . . Upstream transfer electrode
141 . . . Downstream transfer electrode
142 . . . Orthogonal acceleration unit
143 . . . Second acceleration electrode unit
144 . . . Flight tube
145 . . . Reflectron
146 . . . Support member
147 . . . Flight space
148 . . . Detector
151 . . . Temperature control unit
152 . . . Apparatus temperature sensor
153 . . . Indoor temperature sensor
2 . . . Control unit
21 . . . Target temperature setting unit
22 . . . Temperature control section
23 . . . Startup temperature fluctuation prediction unit
24 . . . Notification processing unit
25 . . . Temperature control model information storage unit
26 . . . In-operation temperature fluctuation prediction unit
3 . . . Input unit
4 . . . Notification unit

1. A time-of-flight mass spectrometer comprising:
an ion ejection unit;
a flight tube that forms a space in which ions ejected from the ion ejection unit fly;
a vacuum chamber in which the flight tube is enclosed;
a temperature control unit that controls a temperature of the flight tube; and
a temperature control section that controls a temperature control operation by the temperature control unit based on an indirectly or directly measured temperature of the flight tube and a target temperature,
the time-of-flight mass spectrometer further comprising:
a temperature sensor that measures an ambient temperature, which is a temperature outside the vacuum chamber;
a prediction unit that predicts, based on the ambient temperature and the target temperature, a possibility that the temperature of the flight tube will not reach the target temperature or will not fall within a predetermined allowable temperature range including the target temperature even with the temperature control using the temperature control unit; and
a notification unit that performs a notification to a user according to a prediction result by the prediction unit.

2. The time-of-flight mass spectrometer according to claim 1, further comprising:
a target temperature setting unit that changes the target temperature according to the prediction result by the prediction unit.

3. The time-of-flight mass spectrometer according to claim 1, wherein the prediction unit predicts the possibility that the temperature of the flight tube will not reach the target temperature or will not fall within the predetermined allowable temperature range before execution of temperature control by the temperature control unit or immediately after a start of temperature control.

4. The time-of-flight mass spectrometer according to claim 1, wherein the prediction unit predicts the possibility that the temperature of the flight tube will not reach the target temperature or will not fall within the predetermined allowable temperature range by comparing a difference between the ambient temperature and the target temperature with a predetermined determination reference value.

5. The time-of-flight mass spectrometer according to claim 1, wherein the prediction unit predicts the possibility that the temperature of the flight tube will not reach the target temperature or will not fall within the predetermined allowable temperature range, assuming that the temperature control unit operates in a range between a capability that is lower than a maximum capability by a predetermined margin and a capability that is higher than a minimum capability by a predetermined margin.

6. The time-of-flight mass spectrometer according to claim 1, further comprising:
an in-operation prediction unit that, during execution of temperature control by the temperature control unit after the temperature of the flight tube has reached the target temperature or fallen within the predetermined allowable temperature range, predicts a possibility that the temperature of the flight tube will deviate from the target temperature or from the allowable temperature range, based on the ambient temperature, the target temperature, and the temperature of the flight tube,
wherein the notification unit performs a notification to the user according to a prediction result by the in-operation prediction unit.

7. The time-of-flight mass spectrometer according to claim 6, wherein the in-operation prediction unit predicts a required time until the temperature of the flight tube deviates from the target temperature or from the allowable temperature range, and the notification unit notifies the user of the predicted required time.
